(19) United States
(12) Patent Application Publication
(10) Pub. No.: US 2023/0017327 A1
(43) Pub. Date: Jan. 19, 2023

(54) Tailgate Position Management Systems And Methods

(71) Applicant: Ford Global Technologies, LLC, Dearborn, MI (US)

(72) Inventors: Keith Weston, Canton, MI (US); Derek Bier, Ann Arbor, MI (US); Michael Alan McNees, Flat Rock, MI (US); Andrew Denis Lewandowski, Sterling Heights, MI (US); Brendan Diamond, Grosse Pointe, MI (US); Jordan Barrett, Milford, MI (US)

(73) Assignee: Ford Global Technologies, LLC, Dearborn, MI (US)

(21) Appl. No.: 17/375,463

(22) Filed: Jul. 14, 2021

(51) Int. Cl. B60R 11/04; B60W 50/14; G06K 9/00; G06F 3/0481; H04N 5/232; H04N 5/247

(52) U.S. Cl. CPC B60R 11/04; B60W 50/14; G06K 9/00791; G06F 3/0481; H04N 5/232; H04N 5/247; B60R 2011/004

(57) ABSTRACT

Tailgate position management systems and methods are disclosed herein. An example method includes determining that a tailgate of a vehicle is in a down position, the tailgate comprising a tailgate camera, and selectively adjusting an automatic vehicle assistance feature of the vehicle based on the tailgate being in the down position.

### BACKGROUND

Pickup trucks and other similar vehicles with tailgates may operate with their tailgate down for various reasons. For example, the user of the truck may require a longer bed length for carrying items, and thus may prefer the tailgate to be down. In another example, the tailgate may be down due to user forgetfulness. That is, the user may have placed the tailgate in a down position for a purpose, but may have forgotten to put the tailgate back in its upright position.

When the tailgate is in a down position, the driving experience may be altered. For example, the overall length of the vehicle is longer when the tailgate is in the down position. Driving the truck with the tailgate down may result in damage to the vehicle or other objects due to lack of driver perception or other attendant circumstances.

### BRIEF DESCRIPTION OF THE DRAWINGS

A detailed description is set forth regarding the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 illustrates an example architecture where the systems and method of the present disclosure may be practiced.

FIG. 2 is a schematic diagram of an example vehicle of the architecture of FIG. 1.

FIG. 3 is a screenshot of a graphical user interface provided on a human-machine interface of a vehicle.

FIG. 4 is a flowchart of an example method of the present disclosure.

FIG. 5 is a flowchart of another example method of the present disclosure.

FIG. 6 is a flowchart of yet another example method of the present disclosure.

### DETAILED DESCRIPTION

### Overview

The present disclosure pertains to systems and methods for determining when a vehicle tailgate is down and selectively choosing which camera is used as a backup camera based on the determination. An example system can use image recognition on a backup camera (which may be located on the tailgate) to recognize tailgate-down identifying information, such as a bumper, trailer hitch/license plate/bumper, or another recognizable marker, which may provide a visual indication that the tailgate is down. An example system may also use other sensors(s), such as other cameras on the vehicle, or may use tailgate angle sensors and switches (spring-loaded plunger like those in a car door) as well to assist in the determination of the tailgate position.

If it is determined that the tailgate is down, an alternative sensor(s), such as a second camera other than the backup camera on the tailgate can be used as a backup camera. For example, a truck bed camera may be used or a camera included in a tail light or bumper. Other types of sensors, such as ultrasonic park assist sensors or rear-facing radar may also be used. Additionally, when it is determined that the tailgate is down, the algorithms used for vehicle back-up assistance may be modified to work with the alternative sensor(s) when the tailgate is down. In another example, the braking assist system of the vehicle may also be modified or turned off so that it does not intervene when the tailgate is down.

An example system may also instruct user that the tailgate is down so they can close the tailgate if possible. If the user instructs the vehicle that they cannot or do not want to close the tailgate, then the system can allow the user the option to prevent tailgate ADAS (Advanced Driver Assistance System) intervention such as backup assist or AEB (Automatic Emergency Braking). An example system may also change an orientation of a sensor as to change a field of view to allow for the system to function appropriately. The field of view can be based on estimated angle of tailgate. A zoomed-in view of another camera may also serve as an alternative backup camera that has limited functionality.

### Illustrative Embodiments

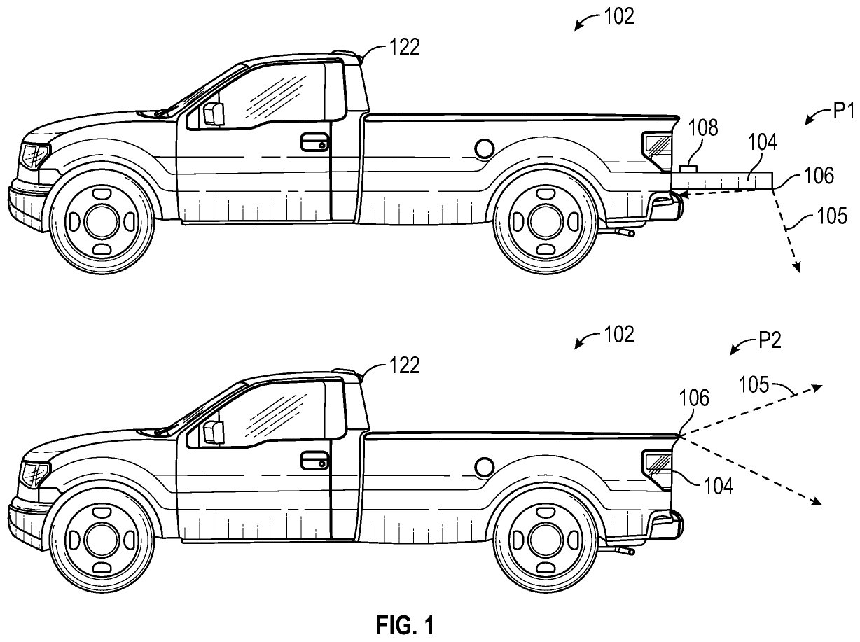

Turning now to the drawings, FIG. 1 depicts an illustrative architecture 100 in which techniques and structures of the present disclosure may be implemented. The architecture 100 includes a vehicle 102 having a tailgate 104. The tailgate 104 can be oriented in a down position P1 or an upright position P2. Some vehicles may be configured with a multi-position tailgate that can be deployed and held at any position between P1 and P2.

The tailgate 104 also has a tailgate camera 106 that is oriented in such a way that the field of view of the camera is approximately orthogonal to the tailgate 104. Thus, when the tailgate is in the upright position P2, the tailgate camera 106 can view what is behind the vehicle within a field 105. When the tailgate 104 is in the down position P1 or is in a position that is not the upright position P2, the tailgate camera 106 view of what is behind the vehicle may be compromised. For example, when the tailgate camera 106 is in the down position P1, the tailgate camera 106 may view the surface underneath the vehicle and certain portions of the vehicle 102 such as a bumper, trailer hitch, and/or license plate. For each vehicle, the view obtained by the tailgate camera 106 may be slightly different, but in any event, the view obtained by the tailgate camera 106 will be different based on whether the tailgate is in the down position P1 or the upright position P2. These differences can be used to determine when the tailgate is down or up.

The vehicle 102 can comprise a tailgate sensor 108, a controller 110, a vehicle sensor platform 112, and a human-machine interface (HMI 114). The tailgate sensor 108 can be used as a dedicated device to detect the position of the tailgate 104. The tailgate sensor 108 can include a spring-loaded plunger. When the plunger is compressed the tailgate can be determined to be down or up (depending on the configuration) position. When the plunger is not compressed (e.g., the plunger is extended by the spring) the tailgate is determined to be in the opposing position. The plunger could be associated with a portion of the frame that defines the bed of the vehicle 102. When the tailgate is closed the tailgate can compress against the plunger that extends from the frame of the bed.

The tailgate sensor 108 can include a tailgate angle sensor that can detect the angle of the tailgate 104. For example, when the tailgate 104 is in the down position P1, the angle is zero degrees. When the tailgate 104 is in the upward position P2, the angle is ninety degrees. Any sensor capable of detecting changes in the angular position of the tailgate can be used as the tailgate angle sensor.

In more detail, the tailgate sensor 108 can be electrically coupled to a controller area network (CAN) and provide signals to the CAN that indicate the tailgate position. A notification can be transmitted through an Accessory Protocol Interface Module (APIM) to the HMI 114 that the view being provided through the HMI 114 is from an alternative camera. The alternative camera includes any other camera that is not the tailgate camera 106. As noted above, this can include a camera mounted in a bed of the vehicle 102.

The tailgate sensor 108 could alternatively include a camera positioned on another portion of the vehicle 102 that is used to detect the position of the tailgate 104. For example, a camera could be located on a cab of the vehicle, a tail light of the vehicle, or a side mirror housing of the vehicle. The images obtained by the camera can be processed by image recognition (as disclosed in greater detail herein) to detect the position of the tailgate 104.

In yet other instances, other sensors included in the vehicle sensor platform 112 can be used in place of the tailgate sensor. These sensors can include but are not limited to, an ultrasonic park assist sensor or rear facing radar sensor that can detect when the tailgate is down based on detecting the signal interference caused when the tailgate is in the down position P1 as opposed to when the tailgate 104 is in the upward position P2. The controller 110 can be trained using signals from the tailgate sensor 108 such as ultrasonic and/or radar to determine tailgate position.

The vehicle 102 may comprise a controller 110 that comprises a processor 116 and memory 118 for storing instructions. The processor 116 executes instructions stored in memory 118 to perform any of the methods disclosed herein. When referring to actions performed by controller 110 or vehicle 102, this implicitly involves the execution of instructions by the processor 116. The controller 110 can be configured to receive data from the tailgate sensor 108 or other vehicle sensors associated with the vehicle sensor platform 112 to detect a position of the tailgate 104. The vehicle sensor platform 112 can include any one or more of various components mounted on the vehicle, such as cameras, LIDAR, IR, ultrasonic, and the like.

The vehicle 102 can also comprise an ADAS 120 that provides advanced driver assistance features such as emergency braking, parking assistance, and the like. The functionality of the ADAS 120 can be modified based on signals received from the controller 110. Non-limiting use case examples are provided herein to elucidate these features.

Again, initially, the controller 110 is configured to determine that the tailgate 104 is in completely down or partially down position. In one example, the controller 110 can make this determination through images obtained by one or more cameras of the vehicle sensor platform 112. For example, images can be captured using a bed camera (not shown) or CHMSL (Center High Mounted Stop Light) camera 122, which may have better point of view depending on the situation, tailgate camera, or other cameras in the vicinity of the tailgate 104 or rear of the vehicle 102. In one configuration, the tailgate 104 can be configured with a secondary tailgate camera mounted on a top surface 115 of the tailgate 104.

When the tailgate is determined to be in the down position by the controller 110, the controller 110 can also select the alternate camera for use as a secondary backup camera. That is, the tailgate camera 106 may be used as a primary backup camera. When the tailgate camera 106 cannot be used as a primary backup camera due to the tailgate being down, another camera mounted somewhere on the vehicle can be used as a secondary backup camera.

In some examples, the controller 110 can utilize a combination of multiple cameras viewpoints in case of adverse conditions like snow which may render image recognition more difficult. In yet another example, the controller 110 can be configured to any combination of sensor output including but not limited to switches, cameras, tailgate angle position, plunger, and the like.

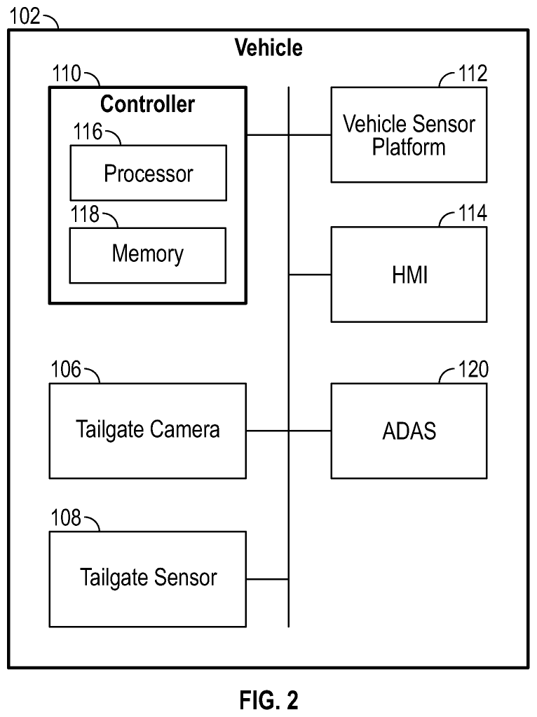

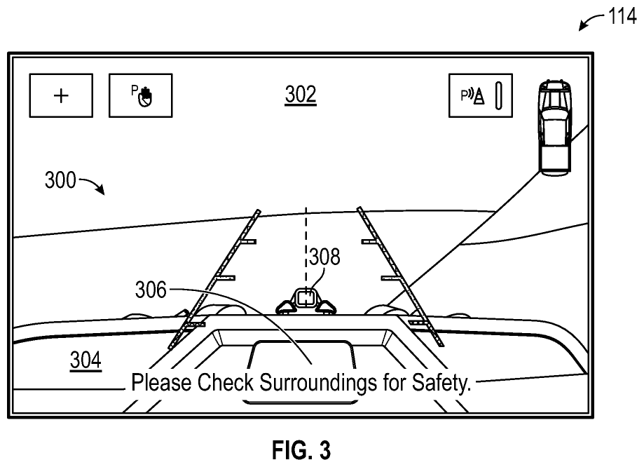

In one example use case, the tailgate camera 106 can obtain images that are processed by the controller 110 using image recognition algorithms (e.g., Image Processing Module “IPMB”). The controller 110 can identify features in the images that are indicative of the tailgate being in the down position P1. Referring now to FIGS. 1-3 collectively, an image 300 can be presented on a graphical user interface (GUI 302) provided on the HMI 114. The controller 110 can process the image 300 to identify artifacts/features such as a bumper 304, license plate 306, and/or tailgate 308. These features, when present in the image 300, indicate that the tailgate 104 is down. In another example, if the tailgate is tilted, but the bumper 304 or license plate 306 are not in view, the controller can process an image to identify other features, such as a road (or other subordinate surface upon which the vehicle is operating such as concrete, gravel, grass, dirt, or the like), which indicate that the tailgate 104 is at least partially angled downwardly.

Collectively and individually, the various features disclosed above can be used to determine or infer a position of the tailgate 104 by the controller 110. Once the position of the tailgate 104 has been determined, various responses can be enacted by the controller 110. Generally, a response can include adjustment or modification of an automatic vehicle assistance feature such as automatic braking and/or another advanced driver assistance feature, such as park distance determinations. As noted above, another response can include selecting an alternate backup camera mounted.

In one example, a user of the vehicle 102 can be informed as to the position of the tailgate 104 through the HMI 114. For example, the HMI 114 can present images obtained by one or more cameras, such as the tailgate camera 106 along with a message regarding the position of the tailgate 104. In some instances, the message regarding the position of the tailgate 104 can be presented on the HMI 114 can be presented without providing the user with images from the camera(s).

The user can confirm whether or not they intend for the tailgate 104 to be down or up. In one example use case a response can include providing a virtual button or other mechanism on the HMI 114 that allows the user to close the tailgate 104. This assumes the tailgate is automated and the tailgate can be closed (e.g., no obstructions prevent closure). However, even if the tailgate can be closed, the user may not want to close the tailgate 104. For example, the user may desire to have the tailgate down to carry a longer load in the bed. In these instances, other vehicle features or functionalities may be modified while the tailgate is maintained in a downward position while the vehicle is operated.

In another example, the user is provided an option to prevent interventions by the ADAS 120 such as rear backup assist or AEB. If the tailgate camera 106 is movable, the controller 110 can change an orientation of the tailgate camera 106 so as to change the field of view. The field of view can be based on estimated angle of tailgate. As noted above, a tailgate angle sensor can be used to determine an angle of the tailgate between P1 and P2. For example, if the tailgate is at 45 degrees, the controller 110 can transmit a signal to a motor or servo coupled to the tailgate camera 106 to adjust the position of the tailgate camera 106 to compensate for the change in the tailgate of 45 degrees. Thus, as the tailgate is moved, the tailgate sensor can be hinged or pivoted correspondingly.

The controller 110 can adjust how the ADAS 120 operates, in some instances. For example, the controller 110 can adjust a rear backup assistance algorithm utilized by the ADAS 120 to ensure that the tailgate 104 does not impact an object. The logic used by the ADAS 120 can determine a distance between an object and a rear of the vehicle. This logic may make this determination with reference to the tailgate being in the upward position (e.g., position P2). To ensure that the tailgate does not impact objects when the vehicle is driven with the tailgate down, the ADAS 120 can modify the logic to account for the extra length of the vehicle 102 due to the tailgate being down. For example, the ADAS 120 can change the distance calculation of the rear backup assistance algorithm to account for this extra vehicle length. By way of example, if the tailgate adds two extra feet to the end of the vehicle when the tailgate is down, the ADAS 120 can modify the rear backup assistance algorithm to account for this added two feet of vehicle length.

Relatedly, the same logic adjustment can be made to the rear brake assist algorithms implemented by the ADAS 120. For example, the ADAS 120 may automatically apply the brakes of the vehicle when the vehicle is within a predetermined distance from an object (and the vehicle appears to be moving without the user interfering with manual braking to avoid impact). This predetermined distance is increased due to the extra vehicle length due to the tailgate being down. This can include adjusting camera settings for the ADAS 120 to optimize for the tailgate down position.

When the tailgate is placed in the upward position P2, the controller 110 can cause the ADAS 120 to automatically adjust the rear backup assistance algorithm and the rear brake assist algorithm to original specifications and operating parameters (e.g., tailgate not down). Thus, the controller 110 can selectively adjust how the ADAS 120 functions based on tailgate position.

In another example, the controller 110 can switch to an alternate camera associated with the bed, CHMSL, cab, bumper, or other vehicle component. By way of example, when the controller 110 determines that the tailgate 104 is not at the upward position P2, one or more ancillary/alternate cameras can be used to obtain images instead of tailgate camera 106. In some instances, a zoomed-in view of a CHMSL camera can be as an alternative backup camera that may have limited functionality.

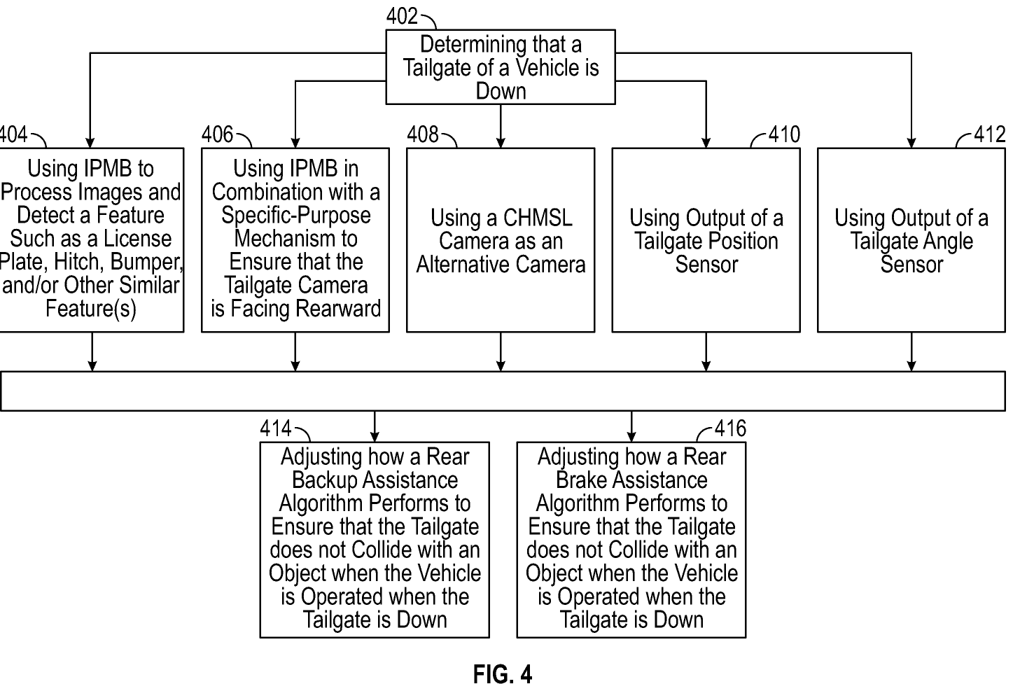

FIG. 4 is a flowchart of an example method of the present disclosure. The method can include a step 402 of determining that a tailgate of a vehicle is down. As noted above, many mechanisms and/or methods can be used to determine when the tailgate of a vehicle is down. For example, mechanical switches or toggles can be used. The tailgate position can be assessed using camera images or other sensor output. Regardless of the method or mechanism used to determine that the tailgate is down, the method involve one or more actions. For example, the method can include a first action 404 of using IPMB to process images and detect a feature such as a license plate, hitch, bumper, and/or other similar feature(s). A second action 406 can include using IPMB in combination with a specific-purpose mechanism to ensure that the tailgate camera is facing rearward. In another example, a third action 408 can include using a CHMSL camera as an alternative camera. In yet another example, a fourth action 410 can include using output of a tailgate position sensor, while a fifth action 412 includes using output of a tailgate angle sensor. It will be understood that any one or combination of the actions listed above can be used. The method can also include a step 414 of adjusting how a rear backup assistance algorithm performs to ensure that the tailgate does not collide with an object when the vehicle is operated when the tailgate is down. The method can also include a step 416 of adjusting how a rear brake assistance algorithm performs to ensure that the tailgate does not collide with an object when the vehicle is operated when the tailgate is down. Again, this can include modifying how these features perform or disabling the features altogether.

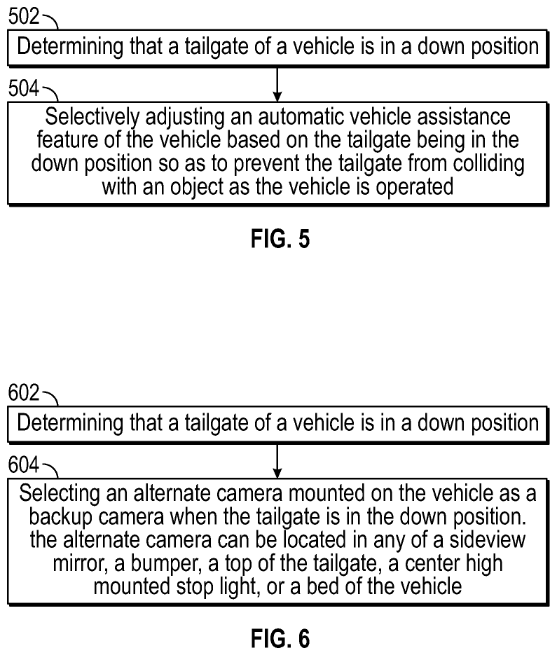

FIG. 5 is a flowchart of an example method of the present disclosure. The method can include a step 502 of determining that a tailgate of a vehicle is in a down position. It will be understood that the tailgate comprises a tailgate camera that is used as a primary backup camera. The tailgate can be determined to be in the down position using any number of techniques disclosed herein such as switches, image recognition, and the like. For example, this can include obtaining images from the tailgate camera (and/or other vehicle cameras) and determining that a tailgate down artifact is in the images using image recognition. The tailgate down artifact is a feature that is present in an image only when the tailgate is down, such as a bumper, a trailer hitch, a license plate, and the like.

The method can also include a step 504 of selectively adjusting an automatic vehicle assistance feature of the vehicle based on the tailgate being in the down position so as to prevent the tailgate from colliding with an object as the vehicle is operated. One example includes adjusting an automatic braking distance of the vehicle to account for a change in overall length of the vehicle due to the tailgate being in the down position. Another example includes selectively adjusting the automatic vehicle assistance feature comprises adjusting a rear backup assistance algorithm of the vehicle to account for a change in overall length of the vehicle due to the tailgate being in the down position. Yet another example includes disabling the automatic vehicle assistance feature altogether.

FIG. 6 is a flowchart of another example method of the present disclosure. The method can include a step 602 of determining that a tailgate of a vehicle is in a down position. Again, the tailgate comprises a tailgate camera that is used as a primary backup camera when the tailgate is in an upward position. The method can also include a step 604 of selecting an alternate camera mounted on the vehicle as a backup camera when the tailgate is in the down position. The alternate camera can be located in any of a sideview mirror, a bumper, a top of the tailgate, a center high mounted stop light, or a bed of the vehicle.

Implementations of the systems, apparatuses, devices, and methods disclosed herein may comprise or utilize a special purpose or general-purpose computer including computer hardware, such as, for example, one or more processors and system memory, as discussed herein. Computer-executable instructions comprise, for example, instructions and data which, when executed at a processor, cause a general-purpose computer, special purpose computer, or special purpose processing device to perform a certain function or group of functions. An implementation of the devices, systems, and methods disclosed herein may communicate over a computer network. A “network” is defined as one or more data links that enable the transport of electronic data between computer systems and/or modules and/or other electronic devices.

Although the subject matter has been described in language specific to structural features and/or methodological acts, it is to be understood that the subject matter defined in the appended claims may not necessarily be limited to the described features or acts described above. Rather, the described features and acts are disclosed as example forms of implementing the claims.

While various embodiments of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described exemplary embodiments but should be defined only in accordance with the following claims and their equivalents. The foregoing description has been presented for the purposes of illustration and description. It is not intended to be exhaustive or to limit the present disclosure to the precise form disclosed. Many modifications and variations are possible in light of the above teaching. Further, it should be noted that any or all of the aforementioned alternate implementations may be used in any combination desired to form additional hybrid implementations of the present disclosure. For example, any of the functionality described with respect to a particular device or component may be performed by another device or component. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

What is claimed is:

1. A method, comprising:
determining that a tailgate of a vehicle is in a down position, the tailgate comprising a tailgate camera; and
selectively adjusting an automatic vehicle assistance feature of the vehicle based on the tailgate being in the down position.

2. The method according to claim 1, wherein determining that the tailgate of the vehicle is in the down position comprises:
obtaining images from the tailgate camera; and
determining that a tailgate down artifact is in the images using image recognition.

3. The method according to claim 2, wherein determining that the tailgate down artifact is in the images includes detecting any one or more of a license plate, a bumper, a trailer hitch, a road or other subordinate surface, and/or combinations thereof.

4. The method according to claim 1, wherein selectively adjusting the automatic vehicle assistance feature comprises adjusting an automatic braking distance of the vehicle to account for a change in overall length of the vehicle due to the tailgate being in the down position.

5. The method according to claim 1, wherein selectively adjusting the automatic vehicle assistance feature comprises adjusting a rear backup assistance algorithm of the vehicle to account for a change in overall length of the vehicle due to the tailgate being in the down position.

6. The method according to claim 1, wherein selectively adjusting the automatic vehicle assistance feature comprises disabling the automatic vehicle assistance feature.

7. The method according to claim 1, further comprising providing a graphical user interface on a human-machine interface of the vehicle, the graphical user interface allowing a user to select that the tailgate should remain in the down position.

8. The method according to claim 1, further comprising selecting an alternative camera when the tailgate camera is unavailable due to the tailgate being in the down position.

9. A vehicle, comprising:
a tailgate;
an advanced driver assistance system; and
a controller comprising a processor and memory, the processor executing instructions stored in the memory to:
determine that the tailgate is in a down position; and
selectively adjust an automatic vehicle assistance feature of the advanced driver assistance system based on the tailgate being in the down position.

10. The vehicle according to claim 9, further comprising a tailgate sensor that outputs a signal that indicates whether the tailgate is in the down position or an upward position.

11. The vehicle according to claim 9, further comprising a tailgate angle sensor that outputs a signal that indicates an angle of the tailgate.

12. The vehicle according to claim 9, further comprising a tailgate camera, the controller being configured to:
obtain images from the tailgate camera; and
determine that a tailgate down artifact is in the images, using image recognition, by detecting any one or more of a license plate, a bumper, a trailer hitch, a road or other subordinate surface, and/or combinations thereof.

13. The vehicle according to claim 12, wherein additional images can be obtained from another camera mounted on the vehicle.

14. The vehicle according to claim 9, wherein the controller is configured to determine that the tailgate is in the down position, using output from ultrasonic or radar sensors.

15. The vehicle according to claim 9, wherein the controller is configured to select an alternative camera for use as a backup camera rather than a tailgate camera, the alternative camera being located in any of a sideview mirror, a bumper, a top of the tailgate, a center high mounted stop light, and/or a bed.

16. The vehicle according to claim 9, wherein the controller selectively adjusts the automatic vehicle assistance feature by at least one of:
adjusting an automatic braking distance of the vehicle to account for a change in overall length of the vehicle due to the tailgate being in the down position;
adjusting the automatic vehicle assistance feature comprises adjusting a rear backup assistance algorithm of the vehicle to account for the change in overall length of the vehicle due to the tailgate being in the down position; or
disabling the automatic vehicle assistance feature.

17. A method, comprising:
determining that a tailgate of a vehicle is in a down position, the tailgate comprising a tailgate camera that is used as a primary backup camera when the tailgate is in an upward position; and
selecting an alternate camera mounted on the vehicle as a backup camera when the tailgate is in the down position.

18. The method according to claim 17, further comprising selectively adjusting an automatic vehicle assistance feature of the vehicle based on the tailgate being in the down position.

19. The method according to claim 17, further comprising:
obtaining images from the tailgate camera or the alternate camera; and
determining that a tailgate down artifact is in the images using image recognition.

20. The method according to claim 19, wherein determining that the tailgate down artifact is in the images includes detecting any one or more of a license plate, a bumper, a trailer hitch, a road or other subordinate surface, or combinations thereof.
